(19) United States
(12) Patent Application Publication
(10) Pub. No.: US 2010/0215472 A1
(43) Pub. Date: Aug. 26, 2010

(54) DEVICE AND METHOD FOR DEPOSITING CONTINUALLY STACKED FLAT MATERIAL PIECES

(75) Inventor: Stephan Scheu, Neuwied (DE)

Correspondence Address: OSHA LIANG L.L.P., TWO HOUSTON CENTER, 909 FANNIN, SUITE 3500, HOUSTON, TX, 77010, US

(73) Assignee: WINKLER + DUENNEBIER AG, Neuwied (DE)

(21) Appl. No.: 12/671,169

(22) PCT Filed: Jul. 15, 2008
(86) PCT No.: PCT/EP2008/005741

§ 371 Date: Jan. 28, 2010

(30) Foreign Application Priority Data
Jul. 28, 2007 (DE) 10 2007 035 438.1

(51) Int. Cl. B65H 31/32; B65G 57/00; B65H 29/22

(52) U.S. Cl. 414/790.1; 414/790.9; 414/802

(57) ABSTRACT

A process for depositing stacked flat material pieces involves receiving the flat material pieces as a stack on a depositing surface in a receiving position, upon achieving of a predetermined number of stacked flat material pieces on the depositing surface, moving an auxiliary depositing surface out of a rest position to a working position, whereby stacking of the stack of flat material pieces on the depositing surface is terminated and a new stack of flat material pieces is formed on the auxiliary depositing surface, moving the depositing surface into a delivery position in which the stack of flat material pieces arranged on the depositing surface is delivered, moving the depositing surface into the receiving position, during which the new stack of flat material pieces then arranged on the auxiliary depositing surface is taken by the depositing surface and further stacked, and moving the auxiliary depositing surface into the rest position.

### 1. AREA OF APPLICATION

The invention relates to a process and an apparatus for depositing flat material pieces and especially for the depositing of continually vertically stacked flat material pieces.

### II. TECHNICAL BACKGROUND

The problem regularly occurs in the processing of flat material pieces in a continuously operating processing apparatus of how the flat material pieces are to be deposited as effectively as possible at the end of the processing.

Potential flat material pieces in this connection are in particular flat material blanks of thin, relatively soft, bendable cardboard that were cut out in the form of folding box blanks for drug boxes of the like in the work steps prior to the depositing or were processed in some other manner. The flat material pieces to be deposited in the present instance can also be formed by blanks from a continuous paper web such as, e.g., letter envelope blanks or labels. Basically, any stackable objects of any material are conceivable as flat material pieces.

Since during the depositing of flat material pieces cut to size from sheets a start can not be made from a uniform, continuous flow of flat material pieces to be deposited but rather, if circumstances so require, from periodically arriving groups of flat material pieces on account of the cut pattern of the sheets and in particular on account of the distance between the individual sheets, that does not necessarily correspond to the distance of two blanks, the concept of a continuous depositing and/or of a continuous stacking is accordingly to be broadly understood in the present application. Consequently, “continuous” should be understood in the sense of “substantially uninterrupted” and the distances in time and space between the flat material pieces to be deposited and/or between the groups of flat material pieces can be different.

On the one hand, it is considered to be desirable for the depositing of such flat material pieces that a continuous operation of the processing apparatus is made possible, i.e., that the running processing of the flat material pieces must not be periodically interrupted in order to remove the flat material pieces that ran up on the place of deposit. On the other hand, the deposited flat material pieces should be deposited in a form that facilitates a further handling of the flat material pieces, for example, during the packaging or the transport.

A vertical stacking of the flat material pieces proved to be ideal here for a further handling of the flat material pieces. Also, a vertical stacking in the case of flat material pieces with an irregular contour is to be preferred since a flat material pieces come to rest in a stable manner in this case on their main surface.

However, a vertical stacking of the flat material pieces unavoidably entails the disadvantage that the stacks created during the depositing must be removed from the depositing position when they reach a certain stack height. However, given a correspondingly desirably high throughput of the processing apparatus, this usually means that the continuously running processing procedure must be interrupted in order to clear the depositing position.

Alternatively, a change could be made between two different depositing positions for the flat material pieces to be deposited, which would be associated, however, with an increased space requirement and a significant control expenditure for the processing technology.

### III. PRESENTATION OF THE INVENTION

### a) Technical Problem

The invention therefore has the problem of creating an apparatus and a process for the depositing of continuously vertically stacked flat material pieces that makes possible an uninterrupted depositing of the flat material pieces.

### b) Solution of the Problem

This problem is solved by an apparatus for the depositing of continuously vertically stacked flat material pieces with the features of claim 1 and by a process for the depositing of continuously vertically stacked flat material pieces with the features of claim 10. Advantageous embodiments result from the particular subclaims.

The process in accordance with the invention comprises at first a depositing surface that can move back and forth between a receiving position and a depositing position. The depositing surface is arranged in the receiving position in such a manner that it receives the flat material pieces to be stacked in the form of at least one substantially vertical stack. The apparatus furthermore comprises an auxiliary depositing surface that can move back and forth between a rest position and a working position. In the working position the auxiliary depositing surface is arranged in such a manner that it receives, instead of the depositing surface, flat material pieces to be stacked in the form of at least one substantially vertical stack.

According to the invention the depositing surface located in the receiving position receives at first the flat material pieces to be deposited in the form of at least one substantially vertical stack. Upon the achieving of a pre-determined number or a certain height of stacked flat material pieces on the depositing surface the auxiliary depositing surface is moved out of the rest position into the working position. As a result thereof, the stacking of the particular stack located on the depositing surface is terminated and at least one new stack of flat material pieces is formed on the auxiliary depositing surface. Then, the depositing surface is moved into its delivery position in which the at least one stack of flat material pieces arranged on the depositing surface is delivered. After the delivery of the stack of flat material pieces arranged on the depositing surface the depositing surface is moved back into the receiving position and the at least one stack of flat material pieces arranged at this time on the auxiliary depositing surface is taken by the depositing surface and further stacked. The auxiliary depositing surface is subsequently moved back again into the rest position.

Although a start is made above from at least one stack of flat material pieces, preferably several stacks of flat material pieces adjacently arranged on the depositing surface or the auxiliary depositing surface are formed at the same time. This is the case, for example, for flat material pieces cut out from flat material sheets if several flat material pieces are arranged adjacent to each other when viewed in the width of the sheet.

The apparatus preferably also comprises a removal apparatus that takes when in the delivery position of the depositing surface the at least one stack of flat material pieces that is then arranged on the depositing surface and transfers it into a final depositing position.

If the predetermined number or the predetermined height of stacked flat material pieces has now been achieved again on the depositing surface the above-presented procedure is preferably repeated from the appropriate step, i.e., from the movement of the auxiliary depositing surface from the rest position into the working position.

This repetition is advantageously carried out until all flat material pieces to be deposited have been deposited from the depositing surface and/or are in the final depositing position.

In order to ensure a reproducible depositing of the flat material pieces on the particular stack, the same depositing position is advantageously always retained. This is achieved in a preferred embodiment of the invention in that the depositing surface and/or the auxiliary depositing surface is/are guided in the receiving position or the working position in accordance with the running height of the stack of flat material pieces.

In the case of a vertical stacking the guiding movement of the depositing surface and/or of the auxiliary depositing surface is advantageously substantially a linear movement directed vertically downward.

In a preferred embodiment of the invention the auxiliary depositing surface is arranged on a rocker arm that can pivot about a pivot axis. In this case the movement of the auxiliary depositing surface between the rest position and the working position takes place substantially by a pivoting of the rocker arm.

This has advantages in particular when the flat material pieces to be stacked are supplied to the depositing surface by a suction roller and are peeled off from the latter optionally by means of a stop in conjunction with a suction brake and peeling-off fingers for a vertical stackwise depositing.

An arrangement of the pivot axis substantially parallel to the axis of the suction roller advantageously makes possible a movement of the auxiliary depositing surface into the working position which movement substantially takes place on a circular track tangentially approaching the surface of the suction roller, so that a more rapid exchange between a depositing of the flat material pieces on the depositing surface and the depositing of the flat material pieces on the auxiliary depositing surface is made possible. The pivot axis can be arranged here in particular vertically above the axis of the suction roller.

The movement of the depositing surface from the receiving position into the delivery position and back preferably takes place by a linear movement running substantially in vertical direction.

In order to ensure a reproducible taking of the at least one stack of flat material pieces present at this time on the auxiliary depositing surface during the movement of the depositing surface from the delivery position back into the receiving position, the depositing surface and the auxiliary depositing surface located in the working position are in planes substantially parallel to one another.

Furthermore, in the preferred embodiment of the invention the depositing surface and the auxiliary depositing surface each have a comb-like structure formed by fingers arranged substantially parallel to each other. The comb-like structures of the depositing surface and of the auxiliary depositing surface are preferably arranged in such a manner here that the two surfaces can run through one another when the auxiliary depositing surface is located in the working position during the movement of the depositing surface from the delivery position back into the receiving position for the taking of the stack of flat material pieces then arranged on the auxiliary depositing surface by the delivery surface, which makes possible a reproducible taking without problems.

The position assumed by the depositing surface during the movement from the depositing position back into the receiving position is advantageously adapted to the height of the stack of flat material pieces arranged at this time on the auxiliary depositing surface so that a continuously continued stacking can take place without delay, during which the depositing surface can then be brought up again immediately after the taking.

If the depositing surface has the above-described, comb-like structure, it can preferably be a conveyor belt formed by several endless rotating belts arranged parallel to each other in the case of the optionally present removal apparatus, and the comb-like structure of the depositing surface is then designed in such a manner that it extends through the belts in the delivery position, i.e., it dips into the intermediate spaces existing between the belts of the conveyor belt in order to make possible a taking of the at least one stack of flat material pieces arranged on the depositing surface by the removal apparatus in order that it can then be transferred by the removal apparatus into the final depositing position.

The removal apparatus preferably transfers the stack of flat material pieces taken from the depositing surface into the final depositing position in a linear movement running substantially horizontally. This linear movement then advantageously runs parallel to the general transport direction of the flat material pieces in the processing direction. However, it would also be conceivable that the linear movement into the final depositing position runs vertically to the general direction of transport of the flat material pieces, during which the final arrangement is a function of the given spatial conditions.

In a special embodiment of the invention the flat material pieces are blanks that that were cut out from a flat material sheet in the processing steps preceding the depositing, among other things. As a consequence, the sequence of the flat material pieces to be continuously stacked has larger gaps in this case conditioned by the distances between the individual sheets at regular intervals.

The movement of the auxiliary depositing surface into the working position can then advantageously take place in time in a controlled manner in that the auxiliary depositing surface reaches the working position substantially at the time at which as a result of a gap no flat material piece is deposited on the stack of flat material pieces arranged on the depositing surface. In this manner the transition of the stack on the depositing surface for the stacking on the auxiliary depositing surface can be carried out without being adversely affected by a flat material piece otherwise possibly arriving just at this time on the depositing position.

In this sense even the movement of the depositing surface from the delivery position into the receiving position can alternatively or additionally take place in a controlled manner in time in such a manner that the taking of the at least one stack of flat material pieces arranged on the auxiliary depositing surface takes place substantially at a time at which due to a gap no flat material piece is deposited on the stack of flat material pieces arranged on the auxiliary depositing surface. This can prevent that the taking of the stack of flat material pieces is adversely affected by a flat material piece otherwise possibly arriving just at this critical time on the depositing position.

Of course, it would also be conceivable in this connection to load the processing apparatus with already individualized flat material pieces in such a manner that the sequence of the flat material pieces to be continuously stacked has greater gaps at regular intervals.

If the sequence of the flat material pieces to be continuously stacked does not have any such greater gaps occurring at regular intervals, then the advantageous embodiment of the process in accordance with the invention described in the following can be used with the supplying of the flat material pieces to be deposited by a suction roller in order to carry out the transition of the stacking on the depositing surface to the stacking on the auxiliary depositing surface as uninfluenced as possible by the flat material pieces arriving on the depositing position.

Since the suction roller preferably holds the flat material pieces to be deposited only in their front area during transport, the rear area of the flat material pieces not held by the suction air tends to project tangentially from the surface of the suction roller on account of the centrifugal forces occurring during the rotation of the suction roller as well as on account of the possibly present intrinsic stiffness of the flat material pieces.

In this manner an approximately wedge-shaped volume is formed between the rear area of the flat material piece held on the suction roller and between the roller surface into which volume the auxiliary depositing surface can penetrate during its movement out of the rest position into the working position. Thus, it is made possible for the auxiliary depositing surface to perform a part of the last section of its movement tangentially approaching the surface into the working position already before the last flat material piece to be stacked on the depositing surface is peeled off from the suction roller without this flat material piece and the auxiliary depositing surface mutually influencing or hindering one another.

The movement of the auxiliary depositing surface into the working position preferably takes place in two stages in this instance. At first, the auxiliary depositing surface is moved out of the rest position into a waiting position as close as possible to the surface of the suction roller. The auxiliary depositing surface then remains in this waiting position until the wedge-shaped volume formed by the last flat material piece to be deposited on the depositing surface and by the surface of the suction roller is located in the immediate vicinity of the auxiliary depositing surface or is just rotating past the auxiliary depositing surface. At this time the auxiliary depositing surface is then is transferred from the waiting position into the working position with a path speed adapted to the rotational speed of the suction roller in a movement substantially tangentially approaching the surface of the suction roller and penetrating into the wedge volume.

### a) EXEMPLARY EMBODIMENTS

An embodiment of the invention is described in detail in the following by way of example using the figures.

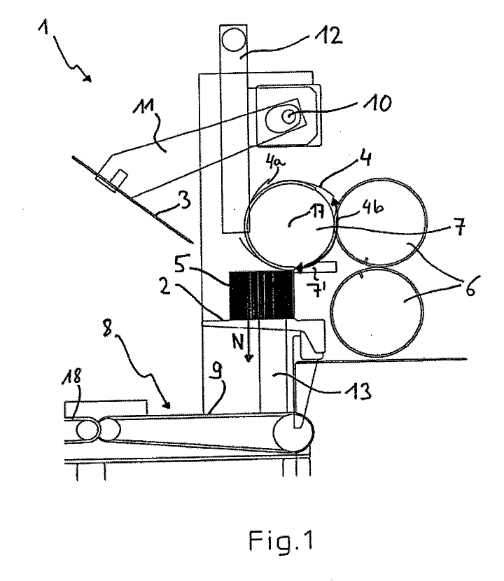

FIG. 1 shows a side view of a preferred embodiment of the apparatus in accordance with the invention in which the depositing surface is in the receiving position and the auxiliary depositing surface in the rest position;

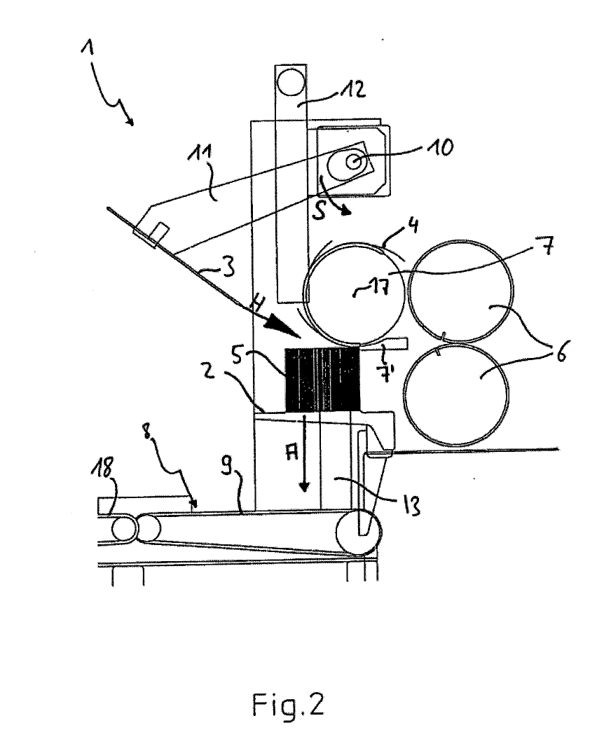

FIG. 2 shows a side view of the apparatus of FIG. 1 during the transition of the auxiliary depositing surface from the rest position into the working position;

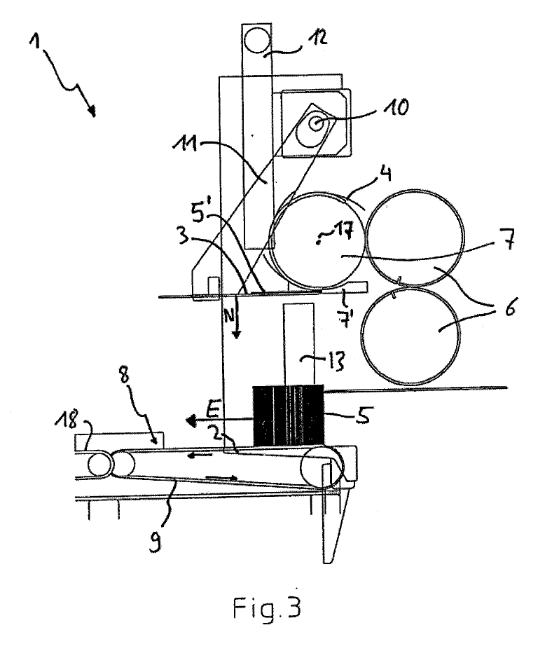

FIG. 3 shows a side view of the apparatus of FIG. 1 in which the depositing surface is in the delivery position and the auxiliary depositing surface is in the working position;

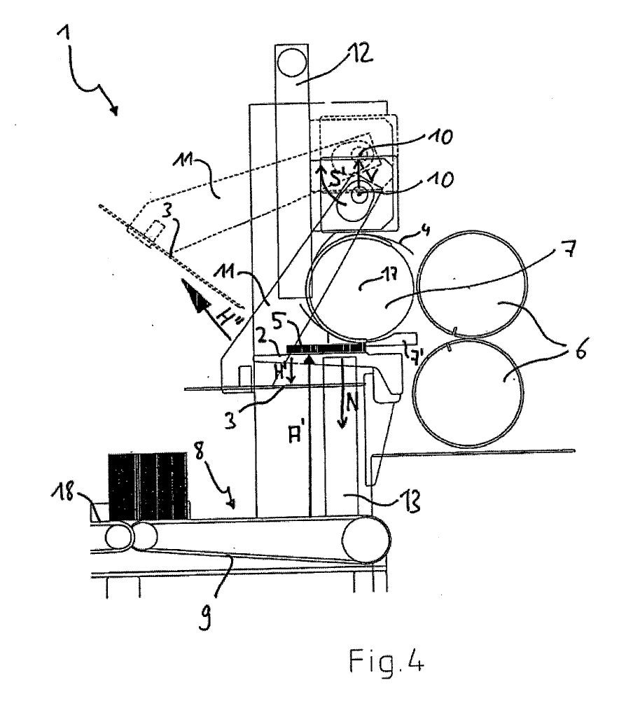

FIG. 4 shows a side view of the apparatus of FIG. 1 in which the depositing surface is again in the receiving position and the transition of the auxiliary depositing surface from the working position into the rest position shown in dotted lines is presented;

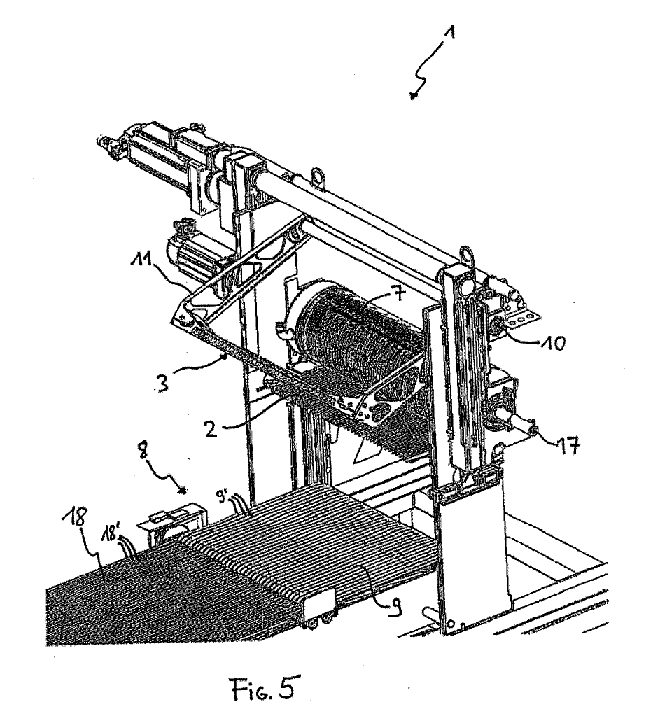

FIG. 5 shows a perspective view of an embodiment of the apparatus in accordance with the invention in which the depositing surface is in the receiving position and the auxiliary depositing surface in the rest position; and

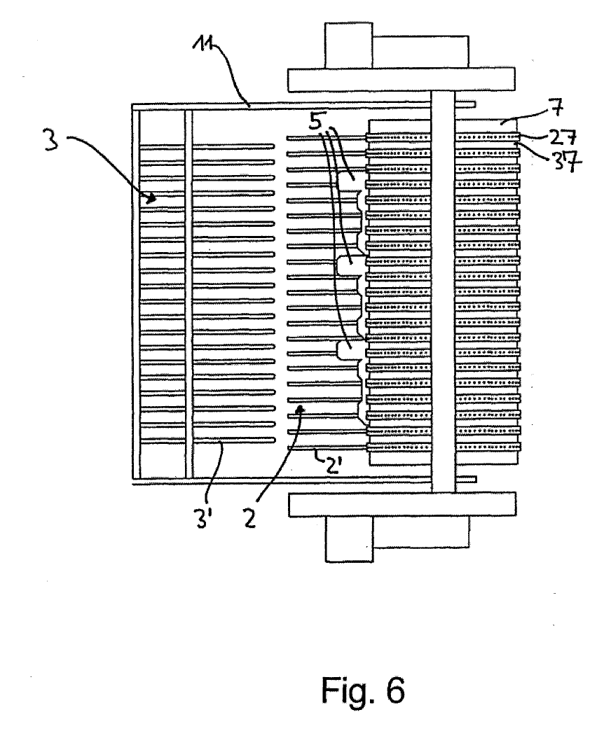

FIG. 6 shows a view onto an embodiment of the apparatus in accordance with the invention in which a presentation of the removal apparatus was not given for reasons of clarity.

FIG. 1 shows an embodiment of the apparatus 1 in accordance with the invention for the depositing of continuously vertically stacked flat material pieces 4. In the embodiment shown flat material pieces 4 cut out of sheets are processed among other things between the rollers 6 and then transferred for depositing onto the suction roller 7. The flat material pieces 4 to be deposited are peeled off from suction roller 7 by known peeling apparatuses 7′, for example, in the form of peeling fingers provided with suction brakes loaded with suction air and moved against a stop so that they are deposited stacked vertically above each other lying on their main surface.

Flat material pieces 4 are held only in their front areas by suction roller 7 in the embodiment shown for the above so that the rear areas of the flat material pieces project substantially tangentially from the surface of roller 7 and define, together with the latter, an approximately wedge-shaped volume 4a. This volume 4a can be used, as was presented above in the general descriptive part, for ensuring an unimpeded movement of auxiliary depositing surface 3 into the working position in that this movement is controlled in such a manner that the auxiliary working surface penetrates into volume 4a.

In FIG. 1 auxiliary depositing surface 3 is in the rest position and flat material pieces 4 peeled off from suction roller 7 are deposited in vertical stacks 5 on depositing surface 2 present in the receiving position. Depositing surface 2 is movably supported in the vertical direction here in a linear guide 13 and is continuously lowered in guiding direction N by a control (not shown) with an appropriate drive in accordance with the height of the stack 5 of flat material pieces deposited on it, so that, when viewed in a vertical direction, the same depositing position for flat material pieces 4 on stacks of flat material pieces 5 is always present.

Auxiliary depositing surface 3 is fastened on a rocker arm that can pivot about pivot axis 10. Pivot axis 10 runs parallel to axis 17 of suction roller 7 in the present case and is arranged in a position vertically above axis 17. Furthermore, pivot axis 10 and therewith also auxiliary depositing surface 3 arranged on it above rocker arm 11 is movably supported in vertical direction in a linear guide 12, and this movement is also brought about by a control (not shown) with an appropriate drive.

Furthermore, apparatus 1 comprises a removal apparatus 8 that comprises in the present case an endless rotating conveyor belt 9. As is apparent in particular from FIG. 5, conveyor belt 9 is formed by several belts 9′ arranged parallel to each other. Conveyor belt 9 is followed by another conveyor belt 18 that is also formed from several belts 18′ arranged parallel to each other. Belts 9′ and 18′ are arranged offset relative to each other here so that conveyor belts 9 and 18 can follow one another substantially without gaps to the extent possible.

As can be recognized in the top view of FIG. 6, depositing surface 2 as well as auxiliary depositing surface 3 have a comb-like structure formed by fingers 2′ and 3′ arranged parallel to each other. Fingers 2′ of depositing surface 2 and fingers 3′ of the auxiliary depositing surface are arranged offset relative to each other so that the two surfaces 2 and 3 can extend through each other without hindrance.

Moreover, fingers 2′ of depositing surface 2 are offset opposite belts 9′ of conveyor belt 9 so that fingers 2′ can engage into the intermediate spaces located between belts 9′.

It is apparent from FIG. 6 that suction roller 7 comprises suction areas arranged annularly on the surface in the present case that are separated from each other by grooves 37. This special arrangement is conditioned by peeling apparatus 7′ whose peeling fingers engage into grooves 37 in order to peel off from roller 7 flat material pieces 4 held on suction areas 27.

In FIG. 2 stacks 5 of flat material pieces arranged on depositing surface 2 have achieved a predetermined height so that auxiliary depositing surface 3 is moved by the appropriate control from its rest position shown in FIG. 1 into its working position. This takes place by a pivoting of rocker arm 11 in the first pivot direction S about pivot axis 10, as a result of which auxiliary depositing surface 3 arranged on rocker arm 11 is brought up in direction H substantially tangentially to the surface of suction roller 7. This tangential movement is made possible by the special arrangement of auxiliary depositing surface 3 on rocker arm 11 as well as by the position of pivot axis 10 to axis 17 of suction roller 7.

Depositing surface 2 with the stacks 5 of flat material pieces arranged on it is moved downwards in linear guide 13 in direction A out of the receiving position into its delivery position that it has reached in FIG. 3, which movement substantially takes place synchronously with the movement of auxiliary depositing surface 3 into the working position.

As a result of this procedure the stacking of flat material pieces 4 on depositing surface 2 is ended and flat material pieces 4 brought up by suction roller 7 and to be deposited are stacked in the form of new stacks 5′ on auxiliary depositing surface 3. The auxiliary depositing surface is continuously lowered here in accordance with the height of stacks 5′ in guiding direction N in linear guide 12 (cf. FIG. 3).

In order to be able to carry out the transition between a stacking of flat material pieces 4 on depositing surface 2 and between a stacking of flat material pieces 4 on auxiliary depositing surface 3 without problems, the movement of auxiliary depositing surface 3 from the rest position into the working position takes place at a time in which no flat material pieces 4 are being peeled off from suction roller 7 for depositing. This is possible since in the present instance three successive flat material pieces 4 to be deposited are cut out from a flat material sheet so that there is a gap 4b between flat material pieces 4 stemming from the first sheet and between the flat material pieces for stemming from the sheet following it, as is indicated in FIG. 1.

As FIG. 3 shows, fingers 2′ of depositing surface 2 enter upon reaching the delivery position into the intermediate spaces present between belts 9′ of conveyor belt 9 of removal apparatus 8 so that stacks 5 of flat material pieces present of depositing surface 2 come to lie on belts 9′. Stacks 5 are then transported by a drive of conveyor belt 9 in the direction shown by the arrows from belt 9 and the following belt 18 in direction E into a final depositing position (not shown) in which the stacks can then be, for example, packaged or further processed in some other manner.

As soon as stack 5 has been completely taken by conveyor belt 9, as shown in FIG. 4, and depositing surface 2 is therefore free again, it is moved in direction A′ out of its delivery position back into its receiving position. The concrete position of depositing surface 2 in the receiving position is adapted here to the height of the stacks 5′ of flat material pieces stacked in the interim on auxiliary depositing surface 3 and to the position of auxiliary depositing surface 3 conditioned by the guiding movement N. Consequently, depositing surface 2 assumes a position just below auxiliary depositing surface 3, during which fingers 2′ and 3′ of depositing surface 2 and of auxiliary depositing surface 3 engage into each other.

As soon as auxiliary depositing surface 3 reaches the height of depositing surface 2 in the framework of its guiding movement N, it is at first lowered vertically downward in direction H′ and then moved into its rest position sketched in dotted lines by a pivoting of rocker arm 11 about pivot axis 10 in pivoting direction S′ and by an upwardly directed movement V of pivot axis 10 in a circular path H″ overlaid by vertical movement V.

The lowering H′ of the auxiliary depositing surface causes the stacks 5′ of flat material pieces arranged on it to be taken by depositing surface 2 and further stacked in the form of stacks 5 while being guided in direction N.

In order to be able to carry out the taking of the stacks 5′ of flat material pieces arranged on auxiliary depositing surface 2 by the depositing surface without problems, the transfer also takes place at a time at which no flat material pieces 4 are being peeled off from suction roller 7 for depositing on account of a gap 4b in the flow of flat material pieces 4 to be deposited.

As soon as the stacks 5 of flat material pieces arranged on depositing surface 2 again reach the predetermined height or the predetermined number of flat material pieces 4 has been deposited, the above-described procedure is repeated until all flat material pieces 4 to be deposited have been stacked and transferred into the end deposition position.

LIST OF REFERENCE NUMERALS

| | |
|---|---|
| 1 | apparatus |
| 2 | depositing surface |
| 3 | auxiliary depositing surface |
| 3′ | fingers of 3 |
| 4 | flat material pieces |
| 4a | wedge-shaped volume |
| 4b | gap |
| 5 | stack of flat material pieces on 2 |
| 5′ | stack of flat material pieces on 3 |
| 6 | working rollers |
| 7 | depositing roller |
| 7′ | peeling apparatus |
| 8 | removal apparatus |
| 9 | conveyor belt |
| 9′ | belts of 9 |
| 10 | pivot axis |
| 11 | rocker arm |
| 12 | linear guide for 3 |
| 13 | linear guide for 2 |
| 17 | suction roller axis |
| 18 | second conveyor belt |
| 18′ | belts of 18 |
| 27 | suction ranges of the suction |
| | roller |
| 37 | grooves in the suction roller |
| N | guiding direction |
| S | first pivoting direction |
| S′ | second pivoting direction |
| H | direction of movement of 3 into |
| | the working position |
| H′ | direction of movement of 3 into |
| | the rest position |
| A | directional movement of 2 into |
| | the delivery position |
| A′ | direction of movement of 2 into |
| | the receiving position |
| E | movement of the stacks into the |
| | final depositing position |
| V | vertical movement of the pivot |
| | axis |

1. An apparatus for the depositing of continually vertically stacked flat material pieces wherein the flat material pieces are supplied by a suction roller, comprising:
a depositing surface that can move back and forth between a receiving position and a depositing position, the depositing surface being arranged in the receiving position such that the depositing surface receives the flat material pieces to be stacked in a form of at least one substantially vertical stack, and
an auxiliary depositing surface that can move back and forth between a rest position and a working position, wherein, in the working position, the auxiliary depositing surface is arranged such that the auxiliary depositing surface receives, instead of the depositing surface, flat material pieces to be stacked in a form of at least one substantially vertical stack,
wherein the auxiliary depositing surface is arranged on a rocker arm that can pivot about a pivot axis extending substantially parallel to the axis of the suction roller, such that the movement of the auxiliary depositing surface between the rest position and the working position takes place substantially by a pivoting of the rocker arm.

2.-4. (canceled)

5. The apparatus according to claim 1, wherein the apparatus further comprises a removal apparatus that, when in the delivery position of the depositing surface, takes the at least one stack of flat material pieces that is then arranged on the depositing surface and transfers the at least one stack of flat material pieces into a final depositing position.

6. The apparatus according to claim 1, wherein the depositing surface and the auxiliary depositing surface each have a comb-like structure formed by fingers arranged substantially parallel to each other.

7. The apparatus according to claim 6, wherein the comb-like structures of the depositing surface and of the auxiliary depositing surface are arranged such that the two surfaces can run through one another when the auxiliary depositing surface is located in the working position.

8. The apparatus according to claim 6, wherein the removal apparatus is a conveyor belt formed by several endless rotating belts arranged parallel to each other, and wherein the comb-like structure of the depositing surface is designed such that the comb-like structure extends through the belts in the delivery position so that the at least one stack of flat material pieces arranged on the depositing surface can be taken from the removal apparatus and transferred into a final depositing position.

9. (canceled)

10. A process for depositing of continually vertically stacked flat material pieces, comprising:
receiving the flat material pieces in the form of at least one substantially vertical stack on a depositing surface located in a receiving position,
upon achieving of a predetermined number of stacked flat material pieces on the depositing surface, moving an auxiliary depositing surface out of a rest position into a working position, whereby stacking of the stack of flat material pieces located on the depositing surface is terminated and at least one new, substantially vertical stack of flat material pieces is formed on the auxiliary depositing surface,
moving the depositing surface into a delivery position in which the at least one stack of flat material pieces arranged on the depositing surface is delivered,
moving the depositing surface into the receiving position, during which the at least one new stack of flat material pieces then arranged on the auxiliary depositing surface is taken by the depositing surface and further stacked, and
moving the auxiliary depositing surface into the rest position,
wherein the flat material pieces to be stacked are supplied to the depositing surface by a suction roller, and the movement of the auxiliary depositing surface from the rest position to the working position takes place by a pivoting about a pivot axis extending substantially parallel to the axis of the suction roller.

11.-12. (canceled)

13. The process according to claim 10, wherein the depositing surface or the auxiliary depositing surface is guided in the receiving position or the working position in accordance with a running height of the at least one stack of flat material pieces.

14. The process according to one of claim 10, wherein the receiving position assumed by the depositing surface is adapted to the height of the new stack of flat material pieces arranged on the auxiliary depositing surface.

15. (canceled)

16. The process according to claim 10, wherein the movement of the auxiliary depositing surface into the working position substantially runs on a circular track that tangentially approaches the surface of the suction roller.

17. The process according to one of claim 10, wherein a sequence of the flat material pieces to be continuously stacked has gaps at regular intervals.

18. The process according to claim 17, wherein the movement of the auxiliary depositing surface into the working position takes place in time in a controlled manner such that the auxiliary depositing surface reaches the working position substantially at a time at which, as a result of a gap, no flat material piece is deposited on the stack of flat material pieces arranged on the depositing surface.

19. The process according to claim 17, wherein the movement of the depositing surface from the delivery position into the receiving position takes place in a controlled manner in time such that the taking of the new stack of flat material pieces arranged on the auxiliary depositing surface takes place substantially at a time at which, due to a gap, no flat material piece is deposited on the new stack of flat material pieces arranged on the auxiliary depositing surface.

20.-22. (canceled)

23. The process according to claim 10, wherein the depositing surface and the auxiliary depositing surface run through one another during the movement of the depositing surface from the delivery position back into the receiving position in order to take the new stack of flat material pieces that is then arranged on the auxiliary depositing surface by the depositing surface.

24. The process according to claim 10, wherein the flat material pieces to be stacked are supplied to the depositing surface by a suction roller, and the movement of the auxiliary depositing surface from the rest position into the working position takes place in two stages, in which the auxiliary depositing surface is transferred in a first step from the rest position into a waiting position of being arranged in the vicinity of the surface of the suction roller, and then in a second step from the waiting position at a track speed adapted to the rotational speed of the suction roller in a movement approaching the surface of the suction roller substantially tangentially from the waiting position into the working position.

25. The apparatus according to claim 1, wherein the axis of the suction roller, the pivot axis, and the rocker arm are arranged such that movement of the auxiliary depositing surface into the working position substantially runs on a circular track that tangentially approaches the surface of the suction roller.
